(19) United States
(12) Patent Application Publication
(10) Pub. No.: US 2023/0265291 A1
(43) Pub. Date: Aug. 24, 2023

(54) COATING LIQUID, COMPOSITE PARTICLE MANUFACTURING METHOD, AND COMPOSITE PARTICLE

(71) Applicant: TOYOTA JIDOSHA KABUSHIKI KAISHA, Toyota-shi (JP)

(72) Inventor: Masaru KUBOTA, Okazaki-shi (JP)

(21) Appl. No.: 18/068,553

(22) Filed: Dec. 20, 2022

(30) Foreign Application Priority Data
Feb. 22, 2022 (JP) 2022-025718

(51) Int. Cl. C09D 1/00; C09D 7/20; H01M 4/62

(52) U.S. Cl. CPC C09D 1/00; C09D 7/20; H01M 4/62

(57) ABSTRACT

The coating liquid includes a solute and a solvent. The solute comprises a phosphoric acid compound. “I₀/(I₀+I₁+I₂)” is 0.7 or less. In the ³¹P-NMR spectrum, I₀ indicates the area of the signal from the PO₄, Q⁰ unit, I₁ indicates the area of the signal from the PO₄, Q¹ unit, and I₂ indicates the area of the signal from the PO₄, Q² unit.

### CROSS-REFERENCE TO RELATED APPLICATION

This application claims priority to Japanese Patent Application No. 2022-025718 filed on Feb. 22, 2022, incorporated herein by reference in its entirety.

### BACKGROUND

### 1. Technical Field

The present disclosure relates to a coating liquid, a composite particle manufacturing method, a composite particle.

### 2. Description of Related Art

WO 2017/094416 discloses immersing a positive electrode active material in a coating forming liquid including lithium metaphosphate.

### SUMMARY

It has been proposed to form a coating film containing phosphorus (P) on a surface of a positive electrode active material particle. Conventionally, for example, an aqueous solution of lithium metaphosphate or the like is used as a coating liquid.

The coating film may coat the surface of the positive electrode active material particle. For example, in a sulfide-based all solid state battery, it is expected that deterioration of the sulfide solid electrolyte be reduced as the coverage is higher. It is considered that the direct contact between the positive electrode active material particle and the sulfide solid electrolyte is reduced. However, when the coating ratio is increased by the conventional coating liquid, the coating film tends to be thicker. The thickening of the coating film may increase a battery resistance.

It is an object of the present disclosure to provide a composite particle including a high coverage and a thin coating film.

Hereinafter, the technical configuration, operation, effects of the present disclosure will be described. However, the mechanism of action herein includes estimation. The mechanism of action does not limit the technical scope of the present disclosure.

1. A coating liquid includes a solute and a solvent. The solute includes a phosphoric acid compound.

The coating liquid satisfies a relationship of the following formula (1).

{I₀/(I₀+I₁+I₂)}≤0.7 (1)

In the above formula (1), I₀ indicates an area of a signal from a Q⁰ unit of PO₄ in a ³¹P-NMR spectrum, I₁ indicates an area of a signal from a Q¹ unit of PO₄ in the ³¹P-NMR spectrum, and I₂ indicates an area of a signal from a Q² unit of PO₄ in the ³¹P-NMR spectrum.

In the coating liquid, the phosphoric acid compound may take various forms. That is, the coating liquid may include various PO₄ units. For example, the coating liquid may include a Q⁰ unit, a Q¹ unit, and a Q² unit. These abundance ratios may determine the solute composition. The Q⁰ unit, the Q¹ unit, and the Q² unit are represented by formulas (1-0) to (1-2) below.

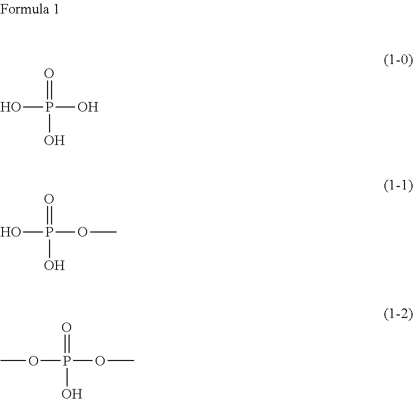

The Q⁰ unit has the configuration of the formula (1-0) above. The Q⁰ unit has no bindings. The Q⁰ unit is considered to be derived from the free PO₄ unit (orthophosphate).

The Q¹ unit has the configuration of formula (1-1) described above. The Q¹ unit has one coupling hand. The Q¹ unit may be derived from, for example, a dimer of PO₄ (P₂O₇).

The Q² unit has the configuration of formula (1-2) described above. The Q² unit has two bindings. The Q² unit is considered to be derived, for example, from a chain-like structure (chain-condensed phosphate).

The above formulas (1-0) to (1-2) are only representative examples of the 10 respective units. Each unit may include various variations. For example, in each of the formulas, “—OH” may be dissociated so that the form of “—O—” is taken. For example, H may be substituted with another element. For example, “—OLi”, “—ONa”, or the like may be adopted.

Hereinafter, the left side of the above formula (1) is also referred to as a “Q⁰ unit ratio”. It is believed that the smaller the Q⁰ unit ratio, the greater the abundance ratio of long molecular chains of phosphoric acid compound.

Conventional coating liquids tend to have a high Q⁰ unit ratio. That is, the conventional coating liquid has a Q⁰ unit ratio greater than 0.7.

According to the new knowledge of the present disclosure, when the Q⁰ unit ratio is reduced to 0.7 or less, the coating ratio is improved and the coating film can be formed thin. It is considered that a coating film having continuity is likely to be formed due to a large abundance ratio of a phosphoric acid compound having a long molecular chain. As a result, it is considered that the coverage is improved and the coating film can be formed thin.

2. The coating liquid may further satisfy, for example, a relationship of the following formula (2).

0.17≤{I₂/(I₀+I₁+I₂)} (2)

When the relationship of the above formula (2) is further satisfied, an improvement in the coverage ratio is expected.

3. The coating liquid may further satisfy, for example, a relationship of the following formula (3).

I₀<I₂ (3)

When the relationship of the above formula (3) is further satisfied, an improvement in the coverage ratio is expected.

4. The coating liquid may further satisfy, for example, a relationship of the following formula (4).

0≤C_{Li}/C_{P}<1.1 (4)

In the above formula (4), C_{Li} represents a molar concentration of lithium in the coating liquid. C_{P} indicates a molar concentration of phosphorus in the coating liquid.

C_{Li}/C_{P} represents a molar ratio (material ratio) of lithium (Li) to P. The molar ratio of less than 1.1 is expected to reduce a precipitate.

5. The solvent may include, for example, water.

6. The solute may include, for example, at least one selected from a group consisting of metaphosphoric acid and polyphosphoric acid.

When metaphosphoric acid and polyphosphoric acid are dissolved in solvents, the Q⁰ unit ratio tends to decrease.

7. The solute may further include, for example, sodium.

The phosphoric acid compound having a long molecular chain can be reduced in molecular weight, for example, by solvolysis. According to the new knowledge of the present disclosure, the stability of a phosphoric acid compound having a long molecular chain may be improved by dissolving sodium (Na) in a coating liquid.

8. A composite particle manufacturing method includes the following (a) and (b).

(a) Preparing a mixture by mixing the coating liquid and a positive electrode active material particle.
(b) Manufacturing a composite particle by drying the mixture.
The composite particle includes the positive electrode active material particle and a coating film. The coating film covers at least a part of a surface of the positive electrode active material particle. The coating film includes phosphorus.

The composite particle may be referred to as a “coated positive electrode active material”. The coating liquid adhering to the surface of the positive electrode active material particle is dried to form the coating film. By using the coating liquid of “1 to 7.” described above, the formation of a thin coating film and the improvement of the coating ratio are expected.

9. (b) described above may include forming the composite particle by, for example, a spray drying method.

10. The composite particle includes a positive electrode active material particle and a coating film. The coating film covers at least a part of a surface of the positive electrode active material particle. The coating film includes phosphorus. The coating film has a thickness of 28.5 nm or less. A coverage ratio measured by X-ray photoelectron spectroscopy is 83% or more.

The coverage may be measured by X-ray Photoelectron Spectroscopy (XPS). When the coverage is 83% or more, for example, it is expected that deterioration of the sulfide solid electrolyte is reduced in the sulfide-based all solid state battery. When the thickness of the coating film is 28.5 nm or less, a reduction in battery resistance is expected. Hereinafter, the “thickness of the coating film” may be abbreviated as a “film thickness”.

11. An all solid state battery includes: a positive electrode layer; a separator layer; and a negative electrode layer. The separator layer is disposed between the positive electrode layer and the negative electrode layer. The positive electrode layer includes the composite particle and a sulfide solid electrolyte.

Hereinafter, an embodiment of the present disclosure (hereinafter, may be abbreviated as the “present embodiment”) and an example of the present disclosure (hereinafter, may be abbreviated as the “present example”) will be described. However, the present embodiment and the present example do not limit the technical scope of the present disclosure.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is an exemplary ³¹P-NMR spectrum.

FIG. 2 is a schematic flow chart of a process of a manufacturing method of composite particles according to the present embodiment.

FIG. 3 is a conceptual diagram showing a composite particle in the present embodiment.

FIG. 4 is a conceptual diagram showing an all solid state battery in the present embodiment.

FIG. 5 is a graph showing the relation between the Q⁰ unit ratio and the coverage ratio.

### DETAILED DESCRIPTION OF EMBODIMENTS

### Definition of Terms

Descriptions of “comprising,” “including,” “having,” and variations thereof (e.g., “consisting of,” etc.) are in open-end form. The open-end format may or may not further include additional elements in addition to the essential elements. The description “consisting of” is in closed form. However, even closed forms do not exclude additional elements that are normally associated impurities or are unrelated to the disclosed technology. The statement “consisting essentially of” is in semi-closed form. In the semi-closed format, the addition of elements that do not materially affect the basic and novel properties of the disclosed technology is allowed.

Expressions such as “may”, “may” and the like are used not in an obligatory sense, but in an acceptable sense, the meaning of “having a possibility of having” rather than the meaning of “having to”.

Elements expressed in the singular also include the plural unless specifically stated otherwise. For example, “particle” may mean not only “one particle” but also “an aggregate of particles (powder, powder, particle group)”.

Unless otherwise specified, the execution order of a plurality of steps, operations, operations, and the like included in various methods is not limited to the description order. For example, multiple steps may proceed simultaneously. For example, a plurality of steps may be back and forth.

For example, a numerical range such as “m to n %” includes an upper limit value and a lower limit value unless otherwise specified. That is, “m to n %” indicates a numerical range of “m % or more and n % or less”. In addition, “m % or more and n % or less” includes “more than m % and less than n %”. Further, a numerical value arbitrarily selected from within the numerical range may be set as a new upper limit value or a new lower limit value. For example, a new numerical range may be set by arbitrarily combining numerical values within the numerical range and numerical values described in other parts, tables, figures, and the like in the present specification.

All numerical values are modified by the term “about.” The term “about” may mean, for example, ±5%, ±3%, ±1%, etc. All numerical values may be approximations that may vary depending on the application of the disclosed technology. All numerical values may be indicated by significant numerals. The measurement value may be an average value in a plurality of measurements. The number of measurements may be three or more, five or more, or ten or more. In general, the higher the number of measurements, the higher the reliability of the average value is expected. The measurements may be rounded to fractions based on the number of significant digits. The measurement value may include, for example, an error associated with a detection limit or the like of the measurement device.

Geometric terms (e.g., “parallel,” “vertical,” “orthogonal,” etc.) should not be construed in a strict sense. For example, “parallel” may deviate somewhat from “parallel” in the strict sense. Geometric terms may include, for example, design, work, manufacturing tolerances, errors, etc. The dimensional relationship in each figure may not coincide with the actual dimensional relationship. Dimensional relationships (length, width, thickness, etc.) in the drawings may be changed to facilitate understanding of the disclosed technology. In addition, some of the configurations may be omitted.

When a compound is represented by a stoichiometric compositional formula (e.g., “LiCoO₂”), the stoichiometric compositional formula is only representative of the compound. The compound may have a non-stoichiometric composition. For example, when lithium cobaltate is expressed as “LiCoO₂”, unless otherwise specified, lithium cobaltate is not limited to a composition ratio of “Li/Co/O=1/1/2”, and may include Li, Co, and O at any composition ratio. In addition, doping, substitution, and the like with trace elements can also be tolerated.

“D50” indicates a particle diameter in which the cumulative frequency from the side having the smaller particle diameter reaches 50% in the volume-based particle diameter distribution. D50 can be measured by laser diffraction.

³¹P-NMR Measure

“³¹P-NMR” indicates phosphorus 31 nuclear magnetic resonance (³¹P Nuclear Magnetic Resonance). The ³¹P-NMR spectrum of the coating liquid can be measured in the following manner. A FT-NMR device is provided. For example, a FT-NMR device “product-name JNM-ECA600II type” (or equivalent) manufactured by JEOL Ltd. may be used. A micro bottom tube having a diameter of 5 mm is filled with a coating liquid (sample). A micro bottom tube is placed in FT-NMR device. The measurement conditions are as follows.

Temperature: Room temperature (20±5° C.)

Pulse width: 30°, 4.0 μs

Repeatability: ACQTM=0.56197 s, PD=30 s

Pulse mode: 31Pbcm

Chemical shift criteria: orthophosphoric acid (0 ppm)

Observed frequency: 242.95 MHz

Observation width: 120 ppm (center observation value: 10 ppm)

Sample rotation speed: 15 Hz

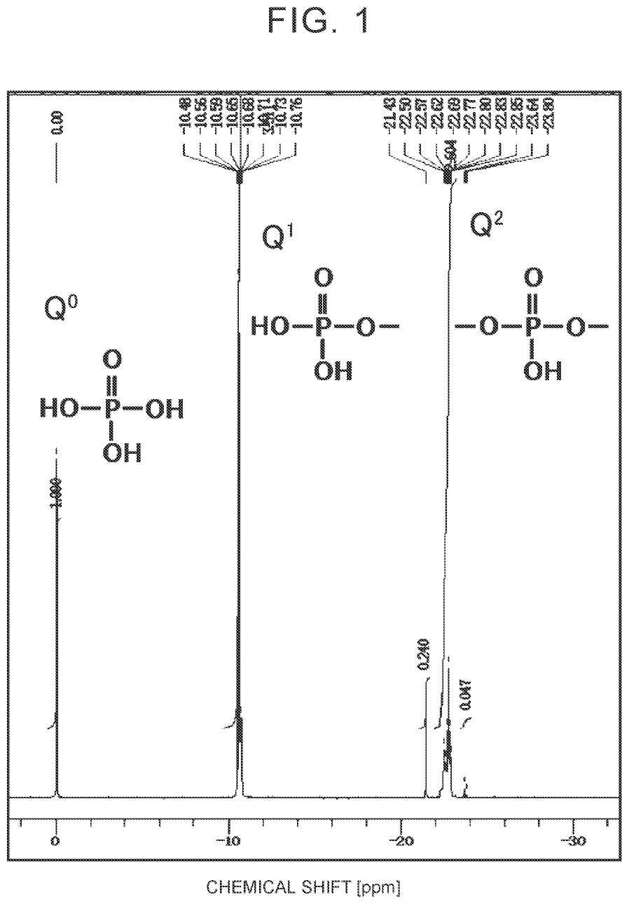

FIG. 1 is an exemplary ³¹P-NMR spectrum.

Signals from the Q⁰ units of PO₄ appear in chemical shifts around 0 ppm. The area (integral value) of the signal is regarded as “10” in Equation (1) above.
Signals from the Q¹ units of PO₄ appear in chemical shifts around-10 to-13 ppm. The area of the signal is considered as “I₁” in equation (1) above.
Signals from the Q² units of PO₄ appear in chemical shifts around-20 to-25 ppm. The area of the signal is considered as “I₂” in equation (1) above.

ICP Measurement

The mass-concentration of Li, P and Na in the coating liquid can be measured by radio-frequency inductively coupled plasma-emission spectroscopy (Inductively Coupled Plasma Atomic Emission Spectroscopy, ICP-AES). The measurement procedure is as follows. By diluting 0.01 g of the coating liquid with pure water, 100 ml of the sample liquid is prepared. An aqueous solution of Li, P, Na (1000 ppm, 10000 ppm) is prepared. A standard solution is prepared by diluting 0.01 g of the aqueous solution with pure water. An ICP-AES device is provided. For example, an ICP-AES device “product-name ICPE-9800” (or equivalent) manufactured by Shimadzu Corporation may be used. The emission intensity of the reference solution is measured by ICP-AES device. A calibration curve is prepared from the emission intensity of the standard solution. ICP-AES device measures the emission intensity of the sample liquid (diluent of the coating liquid). The mass concentration of Li, P, and Na in the coating liquid is determined from the emission intensity of the sample liquid and the calibration curve. In addition, the mass concentration of Li and P is converted to molar concentration. By dividing the molar concentration of Li (C_{Li}) by the molar concentration of P (C_{P}), the molar ratio (C_{Li}/C_{P}) is obtained.

XPS Measurement

The coverage of the composite particles can be measured by XPS. The measurement procedure is as follows. An XPS device is prepared. For example, the XPS device “Product-Name PHIX-tool” (or equivalent) manufactured by ULVAC FIE may be used. A sample powder consisting of composite particles is set in an XPS apparatus. With a pass energy of 224 eV, a narrow scan analysis is performed. The measurement data is processed by the analysis software. For example, an analysis software “MulTiPak” (or equivalent) manufactured by ULVAC FIRE may be used. The ratio of each element is determined from the intensities of the peaks C1s, O1s, P2p, and Mn2p3, Co2P3, Ni2P3. The coverage ratio is determined by the following formula (5).

θ=P/(P+Ni+Co+Mn)×100 (5)

In the above formula (5), θ represents a coverage ratio (%). P, Ni, Co, Mn indicates the ratio of each element.
Here, as an example, a measurement method when the positive electrode active material particles are Li(NiCoMn)O₂ is shown. The right side of the above formula (5) is changed according to the composition of the positive electrode active material particles. For example, when the positive electrode active material grains have LiNiO₂, the right side of the above equation (5) is changed to “P/(P+Ni)×100”.

Film Thickness Measurement

The film thickness (thickness of the coating film) can be measured by the following procedure. The sample is prepared by embedding the composite particles in a resin material. The sample is subjected to a cross-section forming process by an ion milling apparatus. For example, an ion milling device “Arblade 5000” (or equivalent) manufactured by Hitachi High-Technologies may be used. The cross-section of the sample is observed by SEMs (Scanning Electron Microscope). For example, an SEM-device “product-name SU8030” (or equivalent) manufactured by Hitachi High-Technologies may be used. For each of the ten composite particles, the film thickness is measured in 20 fields of view. The arithmetic average of the film thicknesses at a total of 200 positions is regarded as the film thickness.

Coating Liquid

The coating liquid is used to form a coating film on the surface of the positive electrode active material particles. The coating liquid includes a solute and a solvent. The coating liquid may further include, for example, a suspension (insoluble component), a precipitate, and the like.

Solute

The dissolved mass may be, for example, 0.1 to 20 parts by mass, 1 to 15 parts by mass, or 5 to 10 parts by mass with respect to 100 parts by mass of the solvent. Solutes can dissolve in solvents to produce various PO₄ units.

Q⁰ Unit Ratio

Q⁰ unit ratio is determined by “I₀/(I₀+I₁+I₂) [see Equation (1) above]. The coating liquid has a Q⁰ unit fraction of 0.7 or less. As a result, a coating film having a high coverage ratio and a thin coating film are expected to be formed. The lower the Q⁰ unit ratio, the higher the coverage is expected. Q⁰ unit ratio, for example, may be 0.57 or less, may be 0.39 or less, 0.15 or less, may be 0.14 or less, it may be 0.09 or less. The Q⁰ unit ratio may be, for example, zero or 0.09 or more. The Q⁰ unit ratio may be, for example, 0.09 to 0.57.

Q¹ Unit Ratio

Q¹ unit-ratio is determined by “I₁/(I₀+I₁+I₂)”. The coating liquid may have, for example, a Q¹ unit-ratio of greater than 0.05. The Q¹ unit ratio may be, for example, 0.10 or more, or 0.20 or more, or 0.40 or more. The Q¹ unit ratio may be, for example, 0.70 or less, or 0.60 or less, or 0.5 or less. The Q¹ unit ratio may be, for example, 0.40 to 0.47.

Q² Unit Ratio

Q² unit-ratio is determined by “I₂/(I₀+I₁+I₂)”. The coating liquid may have, for example, a Q² unit ratio of greater than 0.01. The higher the Q² unit ratio, the better the coverage is expected. Q² unit ratio, for example, may be 0.03 or more, may be 0.17 or more, may be 0.39 or more, or may be 0.45 or more [see the above equation (2)]. The Q² unit ratio may be, for example, 0.03 to 0.45.

Q² unit ratio may be greater than Q⁰ unit ratio [see Equation (3) above]. The ratio (I₂/I₀) of the ratio of Q² to the ratio of Q⁰ unit may be, for example, 2 or more, 2.6 or more, or 5 or more. The ratio (I₂/I₀) may be, for example, 5 or less. The ratio (I₂/I₀) may be, for example, 1 to 5.

The sum of the Q¹ unit ratio and the Q² unit ratio [(I₁+I₂)/(I₀+I₁+I₂)] may be, for example, 0.40 or more, 0.43 or more, 0.50 or more, 0.62 or more, 0.85 or more, or 0.91 or more. The sum of the Q¹ unit ratio and the Q² unit ratio may be, for example, 1.00 or 0.91 or less. The sum of the Q¹ unit ratio and the Q² unit ratio may be, for example, 0.43 to 0.91. The sum of the Q¹ unit ratio and the Q² unit ratio may be greater than, for example, the Q⁰ unit ratio.

Phosphoric Acid Compounds

The solute comprises a phosphoric acid compound. The solute may comprise any phosphoric acid compound as long as the Q⁰ unit fraction of the coating liquid is 0.7 or less. The solute may comprise, for example, at least one selected from the group consisting of orthophosphoric acid, pyrophosphoric acid, metaphosphoric acid, and polyphosphoric acid. The solute may comprise, for example, at least one selected from the group consisting of metaphosphoric acid and polyphosphoric acid. When metaphosphoric acid and polyphosphoric acid are dissolved in solvents, the Q⁰ unit ratio tends to decrease.

Lithium Compounds

The solute may further comprise a lithium compound. The solute may include, for example, lithium hydroxide, lithium carbonate, lithium nitrate, and the like. The molar ratio of Li to P (C_{Li}/C_{P}) may be, for example, less than 1.1 [see equation (4) above]. By the molar ratio (C_{Li}/C_{P}) is less than 1.1, it is expected that the precipitate will be reduced. The molar ratio (C_{Li}/C_{P}) may be, for example, 1.07 or less, or 0.45 or less, or may be 0. The molar ratio (C_{Li}/C_{P}) may be, for example, 0 to 0.45 or 0.45 to 1.07.

Sodium

The solute may further comprise Na. The dissolution of Na in the coating liquid may improve the stability of the phosphoric acid compound having a long molecular chain. The concentration (mass concentration) of Na in the coating liquid may be, for example, 0 to 1%. The concentration of Na may be, for example, 0.6% or less, or may be 0.5% or less. The concentration of Na may be, for example, 0.5-0.6%.

Solvent

The solvent may comprise any component so long as the solute dissolves. The solvent may include, for example, water, alcohol, and the like. The solvent may include, for example, ion-exchanged water.

Manufacturing Method for Composite Particles

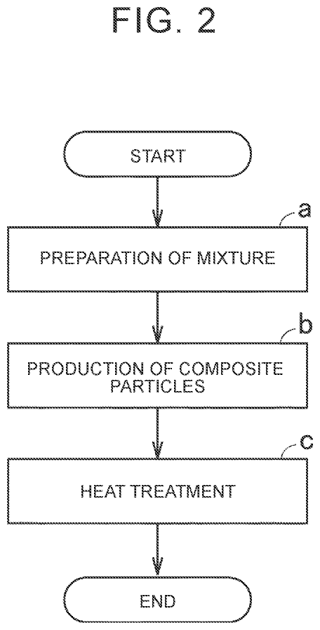

FIG. 2 is a schematic flow chart of a manufacturing method of composite particles according to the present embodiment. Hereinafter, the “manufacturing method of composite particles in the present embodiment” may be abbreviated as “the present manufacturing method”. The manufacturing method comprises “(a) preparation of the mixture” and “(b) preparation of the composite particles”. The manufacturing method may further include, for example, “(c) heat treatment”.

(a) Preparation of Mixtures

The manufacturing method includes preparing a mixture by mixing a coating liquid and positive electrode active material particles. The mixture may be, for example, a suspension or a wet flour. For example, a suspension may be formed by dispersing positive electrode active material particles (powder) in a coating liquid. For example, a wet powder may be formed by spraying a coating liquid into the powder. Any mixing device, granulation device, or the like may be used in the present manufacturing method.

The positive electrode active material particles may be secondary particles (aggregates of primary particles). The positive electrode active material particles (secondary particles) may have, for example, a D50 of 1 to 50 μm, a D50 of 1 to 20 μm, or a D50 of 5 to 15 μm.

One kind of positive electrode active material particles may be used alone, or two or more kinds of positive electrode active material particles may be used in combination. The positive electrode active material particles may include, for example, at least one selected from the group consisting of LiCoO₂, LiNiO₂, LiMnO₂, LiMn₂O₄, Li (NiCoMn)₀₂, Li(NiCoAl)O₂, and LiFePO₄. For example, “(NiCoMn)” in “Li(NiCoMn)O₂” indicates that the sum of the compositional ratios in parentheses is 1. As long as the sum is 1, the amounts of the individual components are optional. Li(NiCoMn)O₂ is, for example, Li(Ni_{1/3}Co_{1/3}Mn_{1/3})O₂, Li(Ni_{0.5}Co_{0.2}Mn_{0.3})O₂, Li(Ni_{0.8}Co_{0.1}Mn_{0.1})O₂, etc.

(b) Production of Composite Particles

The manufacturing method includes producing composite particles by drying the mixture. The coating liquid adhering to the surface of the positive electrode active material particles is dried to form a coating film. Any drying method may be used in the present manufacturing method.

For example, the composite particles may be formed by a spray drying method. That is, the liquid droplets are formed by spraying the suspension from the nozzle. The droplets include positive electrode active material particles and a coating liquid. For example, the droplets may be dried by hot air to form composite particles. The use of a spray drying process is expected to improve the coverage, for example.

The solids fraction of the suspension for spray drying may be, for example, 1-50% or 10-30% by volume. The nozzle diameter may be, for example, 0.1 to 10 mm or 0.1 to 1 mm. The hot air temperature may be, for example, 100 to 200° C.

For example, composite particles may be produced by a rolling fluidized bed coating apparatus. In a rolling fluidized bed coating apparatus, “(a) preparation of a mixture” and “(b) production of composite particles” can be performed simultaneously.

(c) Heat Treatment

The manufacturing method may include subjecting the composite particles to a heat treatment. The coating film may be fixed by heat treatment. The heat treatment here may also be referred to as “calcination”. Any heat treatment apparatus may be used in the present manufacturing method. The heat treatment temperature may be, for example, 150 to 300° C. The heat treatment time may be, for example, 1 to 10 hours. For example, the heat treatment may be performed in air, or may be performed in an inert atmosphere.

Composite Particles

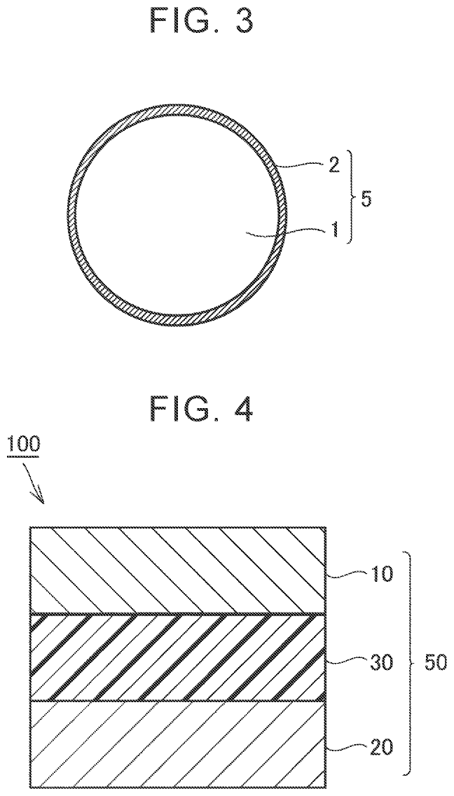

FIG. 3 is a conceptual diagram showing a composite particle in the present embodiment. The composite particles 5 include positive electrode active material particles 1 and a coating film 2. The composite particles 5 may form, for example, aggregates. That is, one composite particle 5 may contain two or more positive electrode active material particles 1. The positive electrode active material particles 1 are cores of the composite particles 5. The details of the positive electrode active material particles 1 are as described above.

The coating film 2 is a shell of composite particles 5. The coating film 2 covers at least a part of the surface of the positive electrode active material particles 1. The composite particles 5 have a coverage of 83% or more. The higher the coverage, the less the degradation of the sulfide solid electrolyte is expected in the all solid state battery. Coverage, for example, may be 85% or more, may be 88% or more, may be 91% or more, it may be 92% or more. The coverage may be, for example, 100% or less, 99% or less, or 95% or less. The coverage may be, for example, 83-92%.

The coating film 2 has a thickness of 28.5 nm or less. The lower the film thickness, the lower the battery resistance is expected. The coating film 2 may have, for example, a thickness of 26.9 nm or less, a thickness of 26.8 nm or less, a thickness of 26.2 nm or less, or a thickness of 25.4 nm or less. The coating film 2 may have, for example, a thickness of 10 nm or more, may have a thickness of 20 nm or more, or may have a thickness of 25.4 nm or more. The coating film 2 may have a thickness of, for example, 25.4 to 28.5 nm.

The coating film 2 contains a phosphorus compound. That is, the coating film 2 includes P. The coating film 2 may further contain Li. The coating film 2 may further contain, for example, oxygen (O), carbon (C), or the like.

All Solid State Battery

FIG. 4 is a conceptual diagram showing an all solid state battery in the present embodiment. The all solid state battery 100 may include, for example, an exterior body (not shown). The exterior body may be, for example, a pouch made of aluminum laminated film. The exterior body may house the power generating element 50. The power generating element 50 includes a positive electrode layer 10, a separator layer 30, and a negative electrode layer 20. That is, the all solid state battery 100 includes the positive electrode layer 10, the separator layer 30, and the negative electrode layer 20. The all solid state battery 100 may further include, for example, a positive electrode current collector, a positive electrode tab, a negative electrode current collector, a negative electrode tab, and the like (all not shown).

Positive Electrode Layer

The positive electrode layer 10 includes composite particles and a sulfide solid electrolyte. Details of the composite particles are as described above. The sulfide solid electrolyte may form an ion conduction path in the positive electrode layer 10. The blending amount of the sulfide solid electrolyte may be, for example, 1 to 200 parts by volume, 50 to 150 parts by volume, or 50 to 100 parts by volume with respect to 100 parts by volume of the composite particles (positive electrode active material). The sulfide solid electrolyte includes, for example, Li, P, and sulfur (S). The sulfide solid electrolyte may further contain, for example, O, silicon (Si), or the like. The sulfide solid electrolyte may further contain, for example, a halogen. The sulfide solid electrolyte may further contain, for example, iodine (I), bromine (Br), and the like. The sulfide solid electrolyte may be, for example, glass ceramics or argyrodite. Sulfide solid-electrolyte, for example, LiI—LiBr—Li₃PS₄, Li₂S—SiS₂, LiI—Li₂S—SiS₂, LiI—Li₂S—P₂S₅, LiI—Li₂O—Li₂S—P₂S₅, LiI—Li₂S—P₂O₅, LiI—Li₃PO₄—P₂S₅, Li₂S—P₂S₅, and at least one selected from the group consisting of Li₃PS₄.

The positive electrode layer 10 may further include, for example, a conductive material. The conductive material may form an electron conduction path in the positive electrode layer 10. The blending amount of the conductive material may be, for example, 0.1 to 10 parts by mass with respect to 100 parts by mass of the composite particles (positive electrode active material). The conductive material may include any component. The conductive material may include, for example, at least one selected from the group consisting of carbon black, vapor-grown carbon fibers (VGCF), carbon nanotubes (CNTs), and graphene flakes.

The positive electrode layer 10 may further include, for example, a binder. The amount of the binder may be, for example, 0.1 to 10 parts by mass with respect to 100 parts by mass of the composite particles (positive electrode active material). The binder may comprise any component. The binder may include, for example, at least one selected from the group consisting of polyvinylidene fluoride (PVdF), vinylidene fluoride-hexafluoropropylene copolymer (PVDF-HFP), styrene-butadiene rubber (SBR), and polytetrafluoroethylene (PTFE).

Negative Electrode Layer

The negative electrode layer 20 is a counter electrode of the positive electrode layer 10. The negative electrode layer 20 includes negative electrode active material particles and a sulfide solid electrolyte. The sulfide solid electrolyte may be common or different between the negative electrode layer 20 and the positive electrode layer 10. The negative electrode layer 20 may further include a conductive material and a binder. The negative electrode active material particles may include an optional component. The negative electrode active material particles may include, for example, at least one selected from the group consisting of graphite, Si, silicon oxide [SiOₓ (0<x<2)], and Li₄Ti₅O₁₂.

Separator Layer

The separator layer 30 is interposed between the positive electrode layer 10 and the negative electrode layer 20. The separator layer 30 separates the positive electrode layer 10 from the negative electrode layer 20. The separator layer 30 includes a sulfide solid electrolyte. The separator layer 30 may further include a binder. The sulfide solid electrolyte may be common or different between the separator layer 30 and the positive electrode layer 10. The sulfide solid electrolyte may be common or different between the separator layer 30 and the negative electrode layer 20.

Production of Composite Particles

The composites according to No. 1 8 were produced as follows: Hereinafter, for example, the term “No. 1 complex” may be abbreviated as “No. 1”.

No. 1

A coating liquid was prepared by dissolving 10.8 parts by mass of orthophosphoric acid (85%, manufactured by Kishida Chemical Co., Ltd.) in 166 parts by mass of ion-exchanged water. In addition, 2.1 parts by weight of lithium hydroxide monohydrate (LiOH H₂O) was additionally dissolved in the coating liquid.

By the above-described steps, Q⁰ unit ratio [I₀/(I₀+I₁+I₂)], molar ratio (C_{Li}<C_{P}), and Na concentration were measured. The results are shown below in Table 1.

Li(Ni_{1/3}Co_{1/3}Mn_{1/3})O₂ was prepared as the positive electrode active material grains. A suspension was prepared by dispersing the powder of the positive electrode active material particles in a coating liquid. A spray dryer “Mini Spray Dryer B-290” from BUCHI was prepared. The suspension was fed to a spray dryer to produce a powder of composite particles. The supply air temperature of the spray dryer was 200° C., and the supply air volume was 0.45 m³/min. The composite particles were heat treated in air. The heat treatment temperature was 200° C. The heat treatment time was 5 hours.

Coverage and film thickness were measured by the above procedure. The results are shown below in Table 1.

A positive electrode layer containing composite particles and a sulfide solid electrolyte was formed. A test cell further comprising a positive electrode layer was produced. The test cells were all solid state cells. The initial resistance of the test cell was measured. The results are shown below in Table 1. The initial-resistance values of Tables 1 below are relative-values. The initial-resistance of No. 4 is defined as 1.

No. 2

A coating liquid was prepared by dissolving 2.7 parts by mass of lithium metaphosphate (manufactured by Mitsuwa Chemical Co., Ltd.) in 50 parts by mass of ion-exchanged water. Except for this, composites and test cells were produced as in No. 1.

No. 3

No. 1 coating liquid and the positive electrode active material particles were mixed to prepare a suspension. The suspension was fed to a spray dryer to produce composite particles. In No. 3, the coating conditions (mixing ratio of the coating liquid and the positive electrode active material particles) were changed so that the coating ratio was high. In addition, test cells were produced in the same manner as No. 1.

No. 4

A coating liquid was prepared by dissolving 10.8 parts by mass of metaphosphoric acid (manufactured by Fujifilm Wako Pure Chemical Industries, Ltd.) in 166 parts by mass of ion-exchanged water. In addition, 2.1 parts by weight of lithium hydroxide monohydrate was additionally dissolved in the coating liquid. Thereafter, composites and test cells were produced as in No. 1.

No. 5

Composite particulates and test cells were produced as in No. 4 except that no lithium-hydroxide monohydrate was added to the coating liquid.

No. 6

Composite particles and test cells were produced as in No. 4 except that the additional amount of lithium hydroxide monohydrate to the coating liquid was altered to alter the molar ratio (C_{Li}/C_{P}).

No. 7

Composite particles and test cells were produced as in No. 4 except that the additional amount of lithium hydroxide monohydrate to the coating liquid was altered to alter the molar ratio (C_{Li}/C_{P}).

No. 8

A coating liquid was prepared by dissolving 10 parts by mass of polyphosphoric acid (product name: polyphosphoric acid-116T, manufactured by Nippon Chemical Industry Co., Ltd.) in 166 parts by mass of ion-exchanged water. Except for this, composites and test cells were produced as in No. 4.

TABLE 1

| | | | | | | | | | | all |
|---|---|---|---|---|---|---|---|---|---|---|
| | coating liquid | | | | | | | composite | | solid |
| | | ³¹P-NMR | | | ICP-AES | | | particles | | state |
| | | Q⁰ | Q¹ | Q² | molar | | | XPS | SEM | battery |
| | phosphoric | unit | unit | unit | ratio | P | Na | mixing | film | initial- |
| | acid | ratio | ratio | ratio | C_{Li}/C_{P} | concentration | concentration | ratio | thickness | resistance |
| No. | compound | [—] | [—] | [—] | [—] | [%] | [%] | [%] | [nm] | [—] |
| 1 | orthophosphoric | 1 | 0 | 0 | 0.45 | 1.5 | 0 | 80 | 23.4 | 10.42 |
| | acid | | | | | | | | | |
| 2 | metaphosphoric | 0.94 | 0.05 | 0.01 | 1 | 1.5 | 0 | 60 | 25.6 | 14.34 |
| | acid Li | | | | | | | | | |
| 3 | orthophosphoric | 1 | 0 | 0 | 0.45 | 1.5 | 0 | 85 | 49.5 | 43.20 |
| | acid | | | | | | | | | |
| 4 | metaphosphoric | 0.14 | 0.47 | 0.39 | 0.45 | 1.5 | 0.6 | 88 | 26.2 | 1.00 |
| | acid | | | | | | | | | |
| 5 | metaphosphoric | 0.57 | 0.4 | 0.03 | 0 | 1.5 | 0.6 | 83 | 28.5 | 1.12 |
| | acid | | | | | | | | | |
| 6 | metaphosphoric | 0.09 | 0.46 | 0.45 | 1.07 | 1.5 | 0.5 | 91 | 26.9 | 1.04 |
| | acid | | | | | | | | | |
| 7 | metaphosphoric | 0.15 | 0.46 | 0.39 | 0.45 | 3 | 0.6 | 92 | 25.4 | 1.03 |
| | acid | | | | | | | | | |
| 8 | polyphosphoric | 0.39 | 0.45 | 0.17 | 0.45 | 1.5 | 0 | 85 | 26.8 | 2.64 |
| | acid | | | | | | | | | |

Each value of the P concentration and the Na concentration shown in Table 1 above is a mass concentration. Each value of the initial resistance shown in Table 1 is a relative value in which the initial resistance of No. 4 is set as 1.

Results

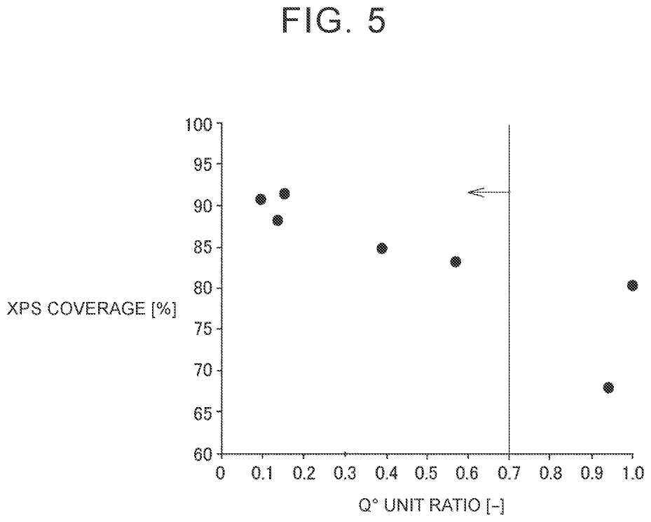

FIG. 5 is a graph showing the relation between the Q⁰ unit ratio and the coverage ratio. In the region where the Q⁰ unit ratio is 0.7 or less, a higher coverage is obtained. The lower the Q⁰ unit, the higher the coverage tends to be. In regions where the Q⁰ unit-ratio is 0.7 or less, the initial-resistance tends to be small (see No. 4 to 8 in Table 1).

In regions where the Q⁰ unit ratio is greater than 0.7, the coverage tends to be low and the initial resistivity tends to be large (see No. 1, 2 of Table 1). It is considered that the positive electrode active material particles are in direct contact with the sulfide solid electrolyte, so that the sulfide solid electrolyte deteriorates.

If the Q⁰ unit ratio is greater than 0.7, the coverage may also be increased, e.g. by adjusting the coating conditions (see No. 3 above Table 1). However, when the Q⁰ unit ratio exceeds 0.7, the film thickness increases as the coverage increases. As the film thickness increases, the initial resistance tends to increase significantly.

The present embodiment and the present example are exemplified in all respects. The present embodiment and the present example are not restrictive. The technical scope of the present disclosure includes all modifications within the meaning and range equivalent to the description of the claims. For example, it is planned from the beginning that any configuration is extracted from the present embodiment and the present example, and those configurations are arbitrarily combined.

What is claimed is:

1. A coating liquid comprising:
a solute; and
a solvent,
wherein the solute includes a phosphoric acid compound,
wherein a relationship of the following formula (1) is satisfied:
{I₀/(I₀+I₁+I₂)}≤0.7 (1),
wherein in the above formula (1),
I₀ indicates an area of a signal from a Q⁰ unit of PO₄ in a ³¹P-NMR spectrum,
I₁ indicates an area of a signal from a Q¹ unit of PO₄ in the ³¹P-NMR spectrum, and
I₂ indicates an area of a signal from a Q² unit of PO₄ in the ³¹P-NMR spectrum.

2. The coating liquid according to claim 1, wherein a relationship of the following formula (2) is further satisfied:
0.17≤{I₂/(I₀+I₁+I₂)} (2).

3. The coating liquid according to claim 1, wherein a relationship of the following formula (3) is further satisfied:
I₀<I₂ (3).

4. The coating liquid according to claim 1,
wherein a relationship of the following formula (4) is further satisfied:
0≤C_{Li}/C_{P}<1.1 (4), and
wherein in the above formula (4),
C_{Li} indicates a molar concentration of lithium in the coating liquid, and
C_{P} indicates a molar concentration of phosphorus in the coating liquid.

5. The coating liquid according to claim 1, wherein the solvent includes water.

6. The coating liquid according to claim 1, wherein the solute includes at least one selected from a group consisting of metaphosphoric acid and polyphosphoric acid.

7. The coating liquid according to claim 1, wherein the solute further includes sodium.

8. A composite particle manufacturing method comprising:
(a) preparing a mixture by mixing the coating liquid according to claim 1 and a positive electrode active material particle; and
(b) manufacturing a composite particle by drying the mixture,
wherein the composite particle includes the positive electrode active material particle and a coating film,
wherein the coating film covers at least a part of a surface of the positive electrode active material particle, and
wherein the coating film includes phosphorus.

9. The composite particle manufacturing method according to claim 8, wherein (b) includes forming the composite particle by a spray drying method.

10. A composite particle comprising:
a positive electrode active material particle; and
a coating film,
wherein the coating film covers at least a part of a surface of the positive electrode active material particle,
wherein the coating film includes phosphorus,
wherein the coating film has a thickness of 28.5 nm or less, and
wherein a coverage ratio measured by X-ray photoelectron spectroscopy is 83% or more.
